(19) United States
(12) Patent Application Publication
(10) Pub. No.: US 2025/0013799 A1
(43) Pub. Date: Jan. 9, 2025

(54) INFORMATION PROCESSING METHOD, INFORMATION PROCESSING APPARATUS, AND RECORDING MEDIUM

(71) Applicant: CANON KABUSHIKI KAISHA, Tokyo (JP)

(72) Inventors: KEISUKE ITO, Kanagawa (JP); KYOHEI HARADA, Kanagawa (JP)

(21) Appl. No.: 18/744,980

(22) Filed: Jun. 17, 2024

(30) Foreign Application Priority Data
Jun. 28, 2023 (JP) 2023-105593

(51) Int. Cl. G06F 30/18; G06F 113/08; G06F 113/14; G06T 11/60

(52) U.S. Cl. CPC G06F 30/18; G06T 11/60; G06F 2113/08; G06F 2113/14

(57) ABSTRACT

An information processing method includes, by a processing unit, displaying, on a display unit, a diagram in which a flow path structure is expressed using a plurality of symbols representing components of a flow path, acquiring a designation of a symbol to be treated as a reference point among the plurality of symbols, calculating a range in which a fluid is allowed to flow from the reference point in the flow path structure using information regarding arrangement of the plurality of symbols and attribute information associated with each of the plurality of symbols, and editing the diagram to identify the range and displaying the edited diagram on the display unit.

### BACKGROUND OF THE INVENTION

### Field of the Invention

The present invention relates to an information processing method, an information processing apparatus, and the like. In particular, the present invention relates to an information processing method, an information processing apparatus, and the like for displaying a flow of a fluid in an apparatus having a flow path structure with high visibility.

### Description of the Related Art

Conventionally, in fields that handle fluids such as water treatment systems and chemical plants, there has been known an apparatus having a flow path structure including equipment through which a fluid flows, such as a pump, a valve, a tank, and a reaction tank, and pipes. When such an apparatus is designed, a diagram generally called a piping and instrumentation diagram (P&ID) is created. In general, in a piping and instrumentation diagram, pipes are expressed as lines, other various devices are expressed as figures, and a flow path structure is expressed by connecting or overlapping the lines and the figures. The lines and figure used in the piping and instrumentation diagram are called symbols. A designer designs a process to be performed in the flow path structure while looking down at the apparatus with reference to the piping and instrumentation diagram.

The number of symbols depicted in the piping and instrumentation diagram increases as the flow path structure of the apparatus becomes more complicated. For this reason, in the case of a piping and instrumentation diagram of a complicated apparatus, it is likely that connection relationships between elements in a flow path structure are difficult for the designer to recognize.

At this point, JP 2008-9516 A describes a method of enhancing visibility of a connection relationship by displaying a point at which symbols are not connected to each other by a pipe in an emphasized manner.

Even if symbols depicted in a piping and instrumentation diagram are connected to each other by a pipe, this may not mean that a fluid necessarily flows therebetween. For example, in a check valve, where the fluid flow direction is determined, a fluid flows in the forward direction but does not flow in the reverse direction. In addition, even if symbols are connected to each other by a pipe, a flow of a fluid (for example, a direction in which the fluid flows) may vary depending on the characteristics of the fluid. For example, in a flow path system in which the fluid is liquid and flows by the action of gravity, in a case where a pipe is installed with a gradient in the vertical direction, the liquid flows from the vertically upper side to the vertically lower side. On the other hand, for example, in a case where gas is handled as a fluid, for example, if the gas is injected into a tank in which liquid is stored, the gas may flow to a pipe connected to an upper end of the tank, but may not flow to a pipe connected to a lower end of the tank.

On the other hand, even if symbols are not connected to each other by a pipe, the fluid may flow therebetween. For example, although a spray ball disposed in the tank is not directly connected to the tank itself by a pipe, when liquid is supplied to the spray ball, the liquid sprayed from the spray ball flows to the inside of the tank.

As described above, in a conventional piping and instrumentation diagram, although a connection relationship between symbols is expressed, for example, when a series of processes is designed, it is difficult for a process designer to accurately grasp at what point of time a fluid exists up to a flow path element corresponding to which symbol. In addition, in the case of a complicated apparatus, a plurality of piping and instrumentation diagrams may be drawn. In this case, it may be difficult for the process designer to grasp up to which flow path element corresponding to a symbol of which diagram a fluid exists.

Therefore, there is need for an information processing method and an information processing apparatus capable of displaying a state of a fluid in a flow path structure (a state in which the fluid flows in the flow path structure) in a piping and instrumentation diagram expressed by using symbols in an easily understandable form.

### SUMMARY OF THE INVENTION

According to a first aspect of the present invention, an information processing method includes, by a processing unit, displaying, on a display unit, a diagram in which a flow path structure is expressed using a plurality of symbols representing components of a flow path, acquiring a designation of a symbol to be treated as a reference point among the plurality of symbols, calculating a range in which a fluid is allowed to flow from the reference point in the flow path structure using information regarding arrangement of the plurality of symbols and attribute information associated with each of the plurality of symbols, and editing the diagram to identify the range and displaying the edited diagram on the display unit.

According to a second aspect of the present invention, an information processing apparatus includes a processing unit. The processing unit is configured to display, on a display unit, a diagram in which a flow path structure is expressed using a plurality of symbols representing components of a flow path, acquire a designation of a symbol to be treated as a reference point among the plurality of symbols, calculate a range in which a fluid is allowed to flow from the reference point in the flow path structure using information regarding arrangement of the plurality of symbols and attribute information associated with each of the plurality of symbols, and edit the diagram to identify the range and display the edited diagram on the display unit.

Further features of the present invention will become apparent from the following description of exemplary embodiments with reference to the attached drawings.

### BRIEF DESCRIPTION OF THE DRAWINGS

FIG. 1 is a schematic diagram for explaining an information processing apparatus according to a first embodiment.

FIG. 2 is a diagram illustrating an example of a diagram display screen.

FIG. 3 is a diagram for explaining symbol arrangement information.

FIG. 4 is a diagram for explaining symbol attribute information.

FIG. 5 is a diagram for explaining symbol connection relationship information.

FIG. 6 is a diagram for explaining flow path connection relationship information.

FIG. 7 is a diagram illustrating an example of a diagram display screen in Example 1.

FIG. 8 is a flowchart illustrating a procedure of a process of generating flow path connection relationship information.

FIG. 9 is a flowchart illustrating a procedure of a process of generating a flow path connection relationship.

FIG. 10 is a flowchart illustrating a procedure of a process of calculating a flow path form.

FIG. 11 is a diagram illustrating an example of a diagram display screen in Example 1.

FIG. 12 is a diagram illustrating an example of a diagram display screen in Example 2.

FIG. 13 is a flowchart illustrating a procedure of a process of adding flow path connection availability.

FIG. 14 is a diagram illustrating an example of a diagram display screen in Example 2.

FIG. 15 is a diagram illustrating an example of a diagram display screen in Example 3.

FIG. 16 is a flowchart illustrating a procedure of a process of adding a flow path connection direction.

FIG. 17 is a diagram illustrating an example of a diagram display screen in Example 3.

FIG. 18 is a diagram illustrating an example of a diagram display screen in Example 4.

FIG. 19 is a schematic diagram for explaining an information processing apparatus according to a second embodiment.

FIG. 20 is a diagram for explaining fluid characteristic information.

FIG. 21 is a diagram for explaining flow path form display range information.

FIG. 22 is a diagram illustrating an example of a diagram display screen in Example 5.

FIG. 23 is a diagram illustrating an example of a diagram display screen in Example 6.

FIG. 24 is a diagram illustrating an example of a diagram display screen in Example 6.

FIG. 25 is a diagram illustrating an example of a diagram display screen in Example 7.

FIGS. 26A and 26B are diagrams illustrating an example of a diagram display screen in Example 8.

### DESCRIPTION OF THE EMBODIMENTS

An information processing method, an information processing apparatus, and the like according to embodiments of the present invention will be described with reference to the drawings. Note that the embodiments to be described below are exemplary, and for example, detailed configurations can be appropriately modified for implementation by those skilled in the art without departing from the gist of the present invention.

Meanwhile, it should be noted that, in the drawings referred to in the following description of embodiments and examples, elements denoted by the same reference numerals have the same functions unless otherwise specified. In the drawings, in a case where a plurality of identical elements is arranged, the reference numerals and explanations thereof may be omitted.

### First Embodiment

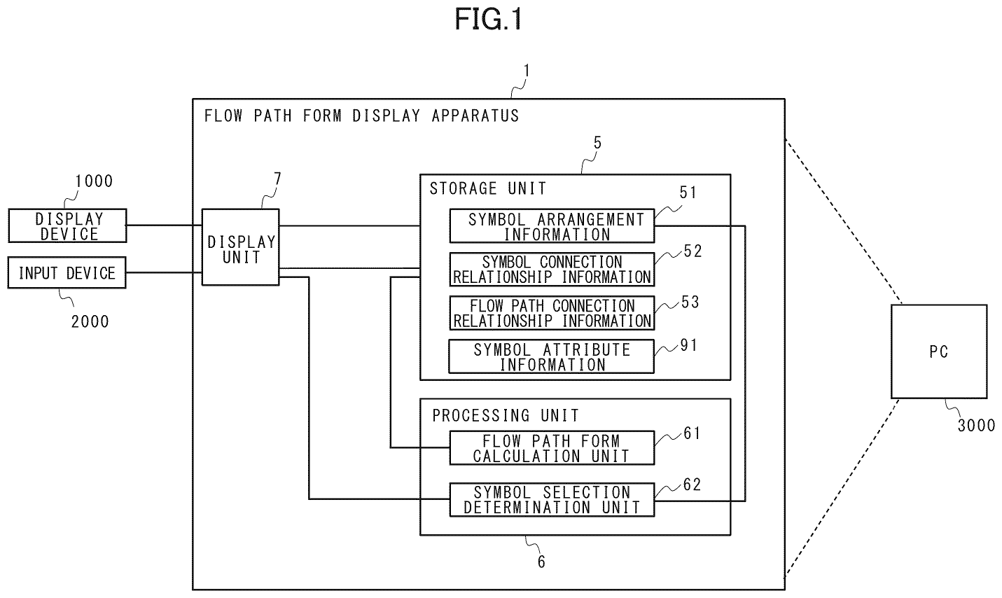

FIG. 1 is a schematic diagram for explaining an information processing apparatus capable of executing an information processing method according to the present embodiment. In the following description, a state of a fluid in a flow path structure may be referred to as a flow path form. The flow path form may refer to, for example, a position where the fluid exists in the flow path structure or a state in which the fluid flows in the flow path structure. Note that an information processing apparatus according to an embodiment may be referred to as a flow path form display apparatus. In addition, an information processing method according to an embodiment may be referred to as a flow path form display method, a flow path form display process, or the like.

### Configuration of Information Processing Apparatus

In FIG. 1, elements necessary for explaining the features of the present embodiment are represented by blocks, but description of general elements not directly related to the problem solving principle of the present invention is omitted. Furthermore, the elements illustrated in FIG. 1 are conceptual, and do not necessarily need to be physically configured as illustrated. For example, the specific form in which the blocks are distributed or integrated is not limited to the illustrated example, and all or some of the blocks can be functionally or physically distributed or combined in arbitrary units according to the usage situation or the like.

As illustrated in FIG. 1, a flow path form display apparatus 1 according to an embodiment includes a storage unit 5, a processing unit 6, and a display unit 7. The blocks illustrated as the elements of the flow path form display apparatus 1 schematically represent functions performed by a PC 3000 executing a processing program and data used when the processing program is executed. Each functional block included in the flow path form display apparatus 1 can be configured using hardware or software. For example, each functional block included in the flow path form display apparatus 1 may be configured by a CPU reading and executing a control program stored in a storage device or a non-transitory recording medium. Alternatively, some or all of the functional blocks may be configured by hardware such as ASIC included in the flow path form display apparatus 1.

The PC 3000 serving as a computer included in the flow path form display apparatus 1 includes a CPU serving as a central processing unit, a ROM and a RAM serving as a storage unit, and an I/O serving as an input/output interface. The ROM can store a processing program for realizing an information processing method to be described below. In addition, the RAM is used as a work area of the CPU or the like when the information processing method is executed. In addition, various external storage devices such as an HDD or an SSD (not illustrated) and an external storage device of another network-mounted system can be connected to the PC 3000 for use as a storage unit together with the ROM and the RAM.

A processing program for realizing a flow path form display process according to an embodiment can be stored in the ROM of the PC 3000 or the external storage device including an HDD, an SSD, or the like. Alternatively, the processing program can be supplied to the above-described storage unit via a computer-readable recording medium such as a flexible disk, an optical disk, a magneto-optical disk, a magnetic tape, a USB memory, or an SSD, and the contents thereof can be updated. Alternatively, the processing program may be written in the storage unit via the network and the I/O.

A display device 1000 is a device for displaying various types of information to be described below to an operator when a flow path form display process is executed, and for example, a liquid crystal display device, an organic EL display device, a projection type display device, or the like can be used.

An input device 2000 is a device for an operator to input various instructions and information when a flow path form display process is executed, and for example, an input device such as a keyboard, a jog dial, a mouse, a pointing device, or a voice input device can be used.

Next, the functions performed by the PC 3000 executing the processing program and the data used when the processing program is executed will be described with reference to FIG. 1.

### Display Unit

The display unit 7 generates screen information for displaying various kinds of information and a flow path form stored in the storage unit 5, and supplies the screen information to the display device 1000. Furthermore, screen information for receiving various types of information and inputs from the input device 2000, screen information for storing the received information in the storage unit 5 or the processing unit 6, or screen information for displaying the received information is generated and supplied to the display device 1000.

### Storage Unit

The storage unit 5 stores various types of information used when the flow path form display process is executed and information obtained by the processing unit 6 to be described below. The various types of information stored in the storage unit 5 may include symbol arrangement information 51, symbol connection relationship information 52, flow path connection relationship information 53, and symbol attribute information 91. However, the configuration of the information stored in the storage unit 5 is not limited to this example. For example, in view of maintainability, the information may be managed by integrating or separating the information or adding log information regarding user operations.

### Processing Unit

When the flow path form display process is executed, the processing unit 6 performs processing of generating information regarding a flow path form while reading and writing various kinds of information stored in the storage unit 5. A symbol selection determination unit 62 included in the processing unit 6 specifies a symbol for which a flow path form is to be displayed on the basis of, for example, an instruction input from the input device 2000 by the user. A flow path form calculation unit 61 included in the processing unit 6 generates information regarding a state in which a fluid is flowing (that is, a flow path form) for the symbol selected by the symbol selection determination unit 62 on the basis of various types of information stored in the storage unit 5. The flow path form calculation unit 61 can store the generated information regarding the flow path form in the storage unit 5.

### Information Processing Method

Next, an information processing method will be described in which the symbol selection determination unit 62 selects a symbol (reference point) for which a flow path form is to be displayed, and the flow path form calculation unit 61 generates information (flow path form) regarding a state in which a fluid flows with respect to the selected symbol, and displays the generated information on the display device 1000.

### Diagram Display Screen

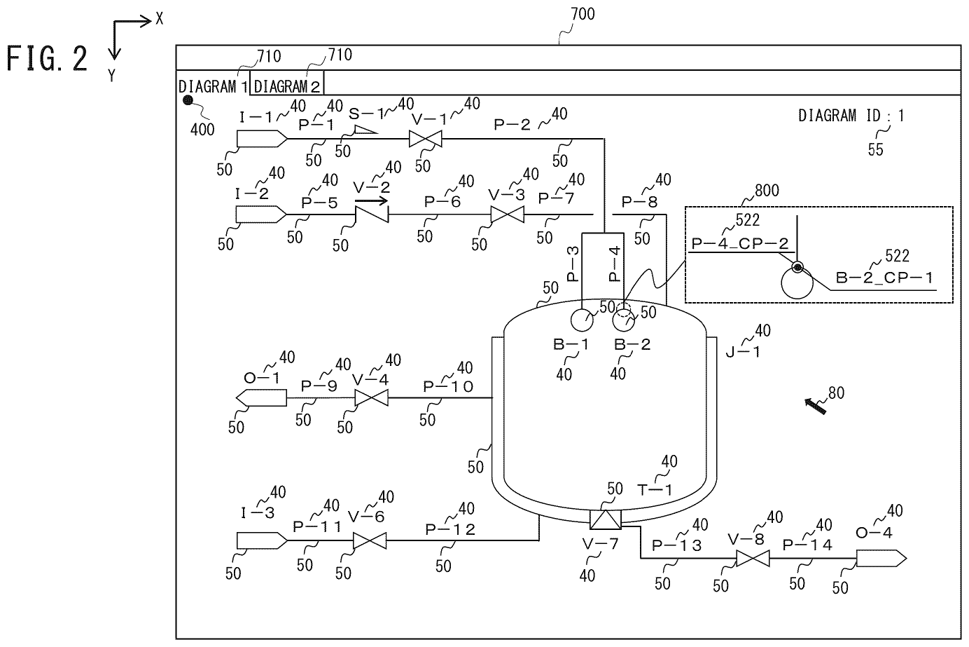

A diagram display screen 700 generated by the display unit 7 and displayed on the display device 1000 will be described with reference to FIG. 2. The diagram display screen 700 is a screen enabling a user to select a symbol (reference point) for which a flow path form is to be generated in a piping and instrumentation diagram, and displaying the flow path form generated for the selected symbol. The diagram display screen 700 may include a diagram tab 710 and a selection cursor 80. In a case where a plurality of piping and instrumentation diagrams are registered, the user can select a piping and instrumentation diagram to be displayed by selecting a diagram tab 710 via the input device 2000. FIG. 2 illustrates a state in which diagram 1 and diagram 2 are registered in the storage unit 5, and a piping and instrumentation diagram of diagram 1 is selected and displayed.

Each piping and instrumentation diagram includes a diagram ID 55 for identifying the piping and instrumentation diagram, a diagram origin 400, a symbol figure 50 representing each element (flow path element) constituting a flow path, and a symbol ID 40 for distinguishing each symbol figure. On the diagram display screen 700, the selection cursor 80 that can be operated by the user is displayed to be superimposed on the piping and instrumentation diagram.

The selection cursor 80 is operated by the user from the input device 2000, and the user can select a symbol figure by placing the selection cursor 80 on the symbol figure 50.

The diagram ID 55 is an ID assigned to each diagram tab 710 by the display unit 7. The diagram origin 400 is a reference position at the time of arranging a symbol figure 50. The symbol figure 50 is a figure indicating a role of each flow path component. The symbol ID 40 is an ID assigned to each symbol figure 50. The display unit 7 creates a diagram tab 710 for each diagram ID 55, and causes the display device 1000 to display a piping and instrumentation diagram in which symbol figures 50 are associated with a symbol ID.

Note that, in FIG. 2, an enlarged view 800 is shown as supplementary information regarding a connection relationship between symbols. The display unit 7 can also display the enlarged view 800 on the diagram display screen 700 as illustrated in FIG. 2. According to the enlarged view 800, a symbol ID 40 “B-2” has a connection point with a symbol ID 40 “P-4” that is a pipe, and has a connection point ID 522 “B-2_CP-1” as an identifier of the connection point. Similarly, the symbol ID 40 “P-4” has a connection point with the symbol ID 40 “B-2”, and has a connection point ID 522 “P-4_CP-2” as an identifier of the connection point. These connection relationships are managed as symbol connection relationship information 52 to be described below.

Although there is a similar connection relationship between a connection point of a symbol expressed as a line and a connection point of a symbol adjacent thereto, the illustration thereof is omitted in the exemplified diagram display screen 700. In addition, in the present text, in order to make it easy to understand a relationship between a connection point and a symbol having the connection point, “{symbol ID 40 having connection point}_CP-{serial number for each symbol}” is adopted as a rule for naming a connection point ID 522.

### Symbol Arrangement Information

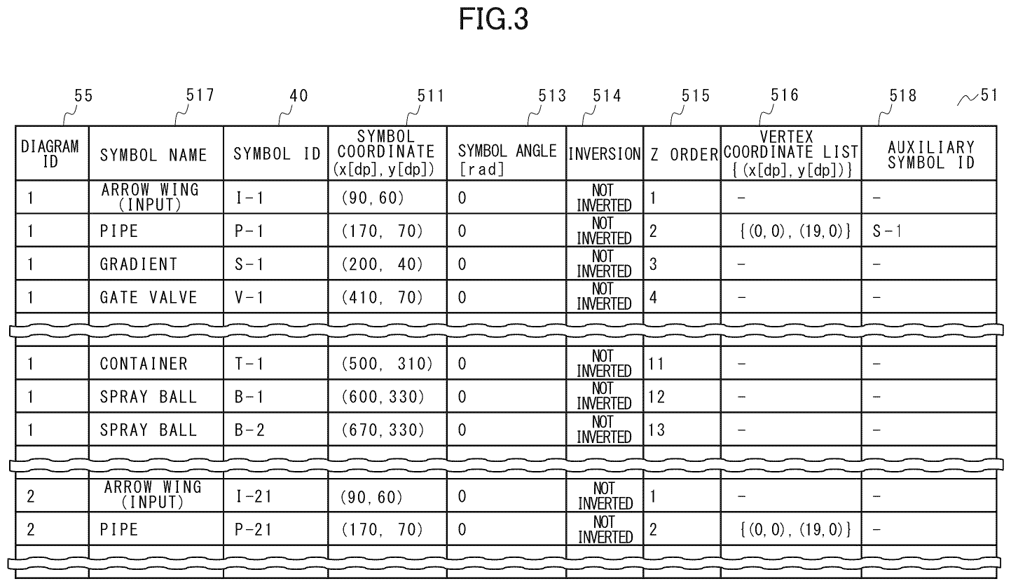

The symbol arrangement information 51 stored in the storage unit 5 of FIG. 1 will be described with reference to FIG. 3. The symbol arrangement information 51 is information used when the display unit 7 generates a diagram display screen 700 and displays the diagram display screen 700 on the display device 1000, and includes information regarding the arrangement of symbols. The symbol arrangement information 51 includes a diagram ID 55, a symbol ID 40, a symbol coordinate 511, a symbol angle 513, an inversion 514, a Z order 515, a vertex coordinate list 516, an auxiliary symbol ID 518, and a symbol name 517.

The symbol name 517 is a character string indicating a type or a shape of a symbol to be arranged, and is information associated with unique information for each symbol. The symbol coordinate 511 is a position at which each symbol figure 50 is displayed with respect to the diagram origin 400. The symbol angle is information indicating a counterclockwise rotation angle with respect to the center position of the symbol figure 50. The inversion 514 is information indicating whether the symbol figure 50 is vertically inverted or horizontally inverted. The Z order 515 indicates an overlapping order of symbol figures 50 in a piping and instrumentation diagram, and the symbol figures are displayed in such a manner that a symbol figure having a smaller Z-order value is disposed closer to the bottom of the overlap, and a symbol figure having a larger Z-order value is disposed closer to the top of the overlap. The vertex coordinate list 516 is a value to be referred to when a shape type 543 to be described below is a line, and includes two or more vertex coordinates. The auxiliary symbol ID 518 is symbol-associated information indicating a characteristic of a symbol such as a gradient symbol, and a symbol ID 40 is stored as the auxiliary symbol ID 518. Note that, concerning the symbol coordinate 511 and the vertex coordinate list 516, [dp], which is a device-independent pixel, is adopted as a unit in order to express a coordinate and a size, but the unit is not limited thereto, and a unit that is easy to handle in a usage environment may be used.

### Symbol Attribute Information

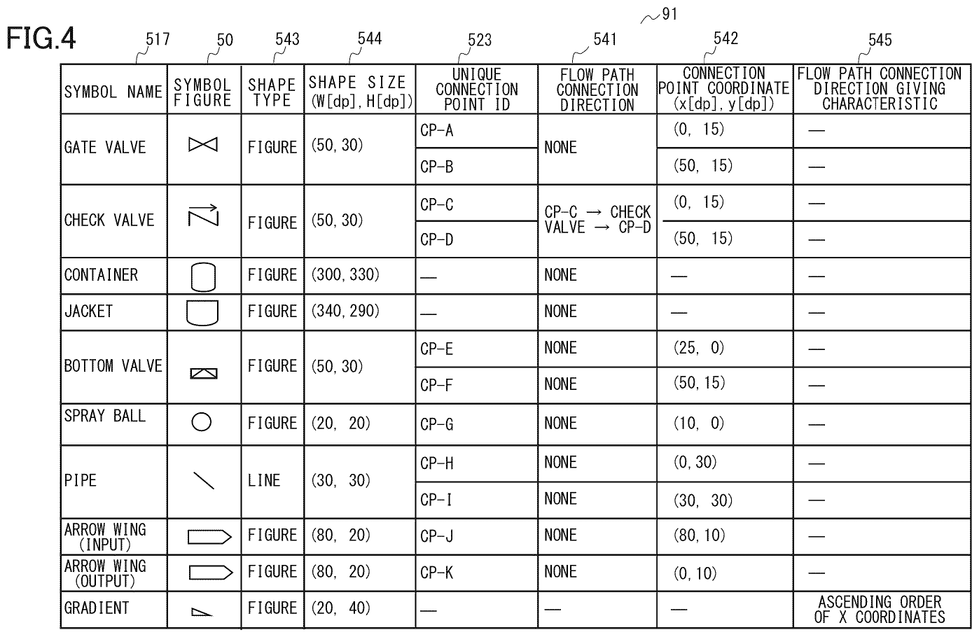

The symbol attribute information 91 will be described with reference to FIG. 4. The symbol attribute information 91 includes unique information corresponding to each symbol name 517 indicating a type of a symbol. The symbol attribute information 91 includes a symbol name 517, a symbol figure 50, a shape type 543, a shape size 544, a unique connection point ID 523, a flow path connection direction 541, a connection point coordinate 542, and a flow path connection direction giving characteristic 545. The shape type 543 is information indicating whether the symbol figure 50 is a figure or a line. The shape size 544 is information indicating a width and a height of a circumscribed rectangle for the symbol figure 50. The unique connection point ID 523 is an ID given to a connection point disposed at a particular position of the symbol figure 50 among connection points of the symbol with other symbols. The connection point coordinate 542 is connection point coordinate with respect to the upper left side of the circumscribed rectangle of the symbol figure 50. The flow path connection direction 541 indicates a direction in which the fluid may flow at a symbol and a connection point. The flow path connection direction giving characteristic 545 is information indicating a calculation method for giving a flow path connection direction 541, when a symbol is registered as an auxiliary symbol ID 518 (FIG. 3), to a connection point of an associated symbol ID 40.

### Symbol Connection Relationship Information

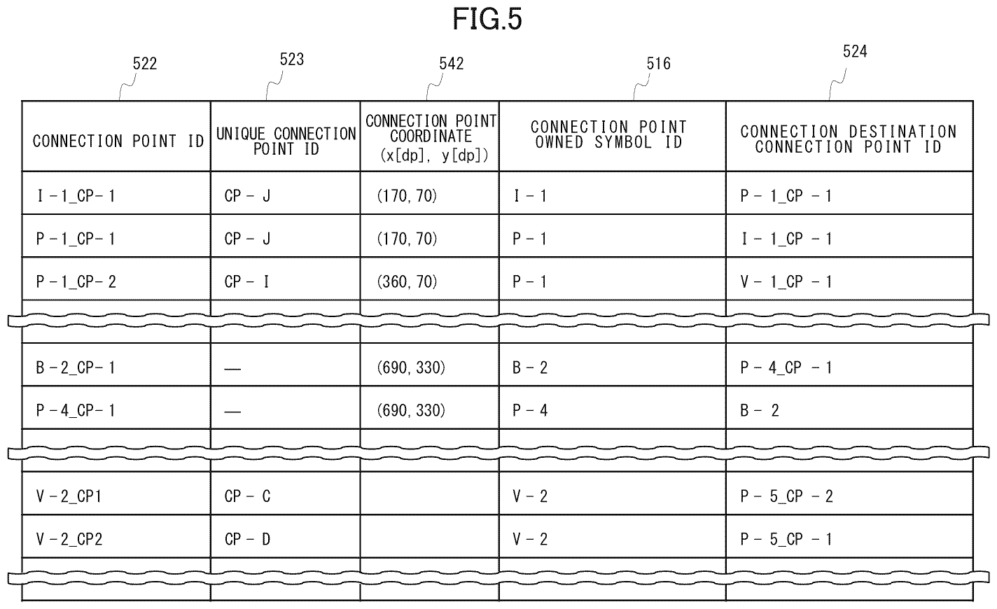

The symbol connection relationship information 52 will be described with reference to FIG. 5. The symbol connection relationship information 52 is information indicating a connection relationship between connection points of symbols. The symbol connection relationship information 52 includes a connection point owned symbol ID 516, a connection point coordinate 542, a connection point ID 522, a unique connection point ID 523, and a connection destination connection point ID 524. The connection point owned symbol ID 516 is a symbol ID 40 that owns a connection point ID 522 to be described below. The connection point ID 522 is an ID allocated to each connection point of a symbol by the display unit 7. The connection destination connection point ID 524 is a connection point ID indicating a connection point connected to the connection point indicated by the connection point ID 522.

### Flow Path Connection Relationship Information

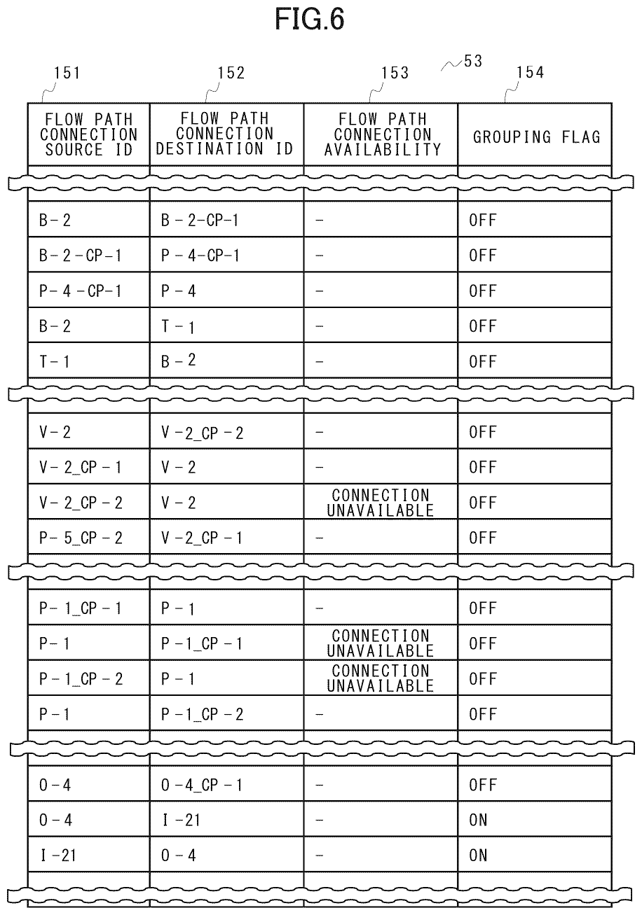

The flow path connection relationship information 53 will be described with reference to FIG. 6. The flow path connection relationship information 53 is information referred to when the flow path form calculation unit 61 generates a flow path form and indicating a connection relationship as a flow path. The flow path connection relationship information 53 includes a flow path connection source ID 151, a flow path connection destination ID 152, flow path connection availability 153, and a grouping flag 154. The flow path connection source ID 151 and the flow path connection destination ID 152 indicate a direction of the flow path form (a direction in which the fluid flows in the flow path structure), and indicate that the fluid is allowed to flow to the flow path connection destination ID 152 when the fluid flows into the flow path connection source ID 151. In addition, symbol IDs 40 are stored as the flow path connection source ID 151 and the flow path connection destination ID 152. The flow path connection availability 153 indicates whether or not the flow path connection source ID 151 and the flow path connection destination ID 152 are included in the flow path form. The grouping flag 154 is a flag indicating whether or not the flow path connection source ID 151 and the flow path connection destination ID 152 are regarded as the same symbol.

### Example 1

Next, an example of an information processing method will be described. The symbol selection determination unit 62 receives a user's selection of a symbol (reference point) for which a flow path form is to be displayed, and the flow path form calculation unit 61 generates and displays information regarding a state (flow path form) in which a fluid flows with respect to the selected symbol. As will be described below, in the present example, a flow path form is calculated from an overlapping order of the symbols and a connection relationship between the symbols.

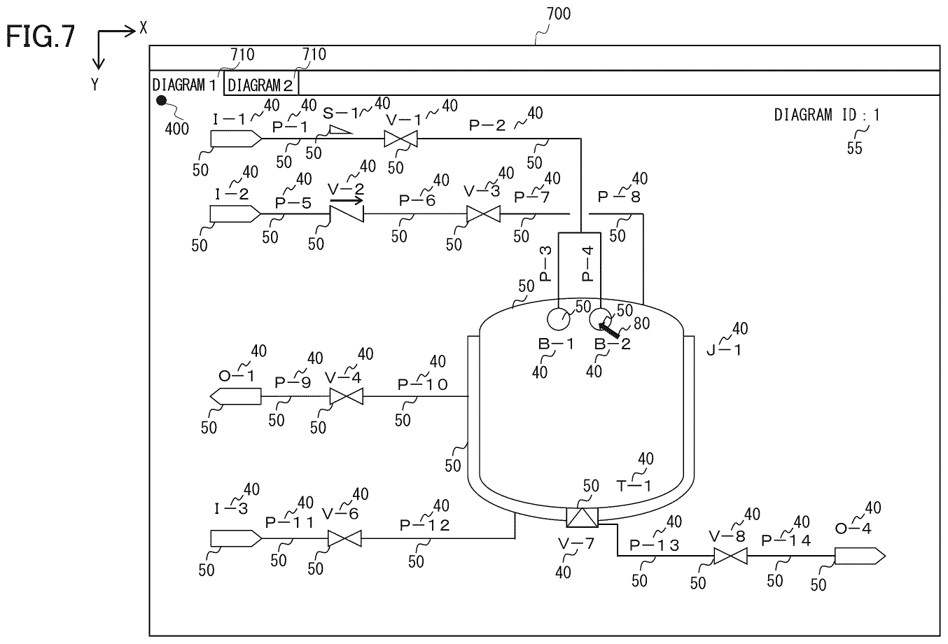

FIG. 7 illustrates a diagram display screen 700 generated by the display unit 7 and displayed on the display device 1000 when the user selects a spray ball of which the symbol ID 40 is “B-2” using the selection cursor 80.

Generation of Flow Path Connection Information from Symbol Connection Relationship

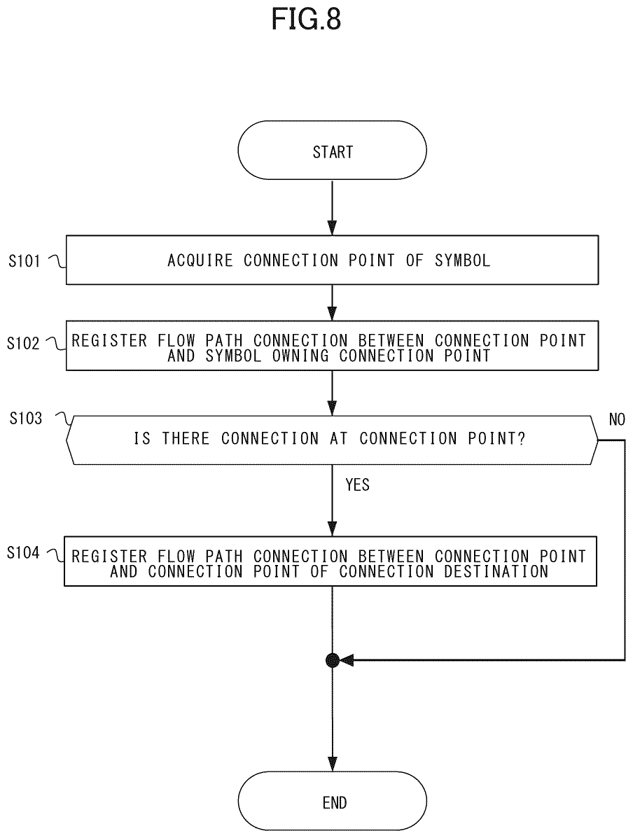

The flow path form calculation unit 61 generates flow path connection relationship information 53 from the selected symbol. A process in which the flow path form calculation unit 61 generates flow path connection relationship information 53 using symbol connection relationship information 52 will be described with reference to a flowchart of FIG. 8.

First, in step S101, the flow path form calculation unit 61 acquires symbol connection relationship information 52. Subsequently, in step S102, the flow path form calculation unit 61 registers a connection point owned symbol ID 516 as a flow path connection source ID 151, and registers a connection point ID 522 as a flow path connection destination ID 152. In addition, the flow path form calculation unit 61 registers the connection point owned symbol ID 516 as a flow path connection destination ID 152, and registers the connection point ID 522 as a flow path connection source ID 151.

Subsequently, in step S103, the flow path form calculation unit 61 checks whether a connection destination connection point ID 524 is registered at the connection point. When a connection destination connection point ID 524 is registered at the connection point, the flow path form calculation unit proceeds to step S104 (step S103: YES), and when no connection destination connection point ID 524 is registered at the connection point, the flow path form calculation unit ends the process (step S103: NO).

Subsequently, in step S104, the flow path form calculation unit 61 registers the connection point owned symbol ID 516 as a flow path connection source ID 151, and registers the connection destination connection point ID 524 as a flow path connection destination ID 152. In addition, the flow path form calculation unit 61 registers the connection point owned symbol ID 516 as a flow path connection destination ID 152, and registers the connection destination connection point ID 524 as a flow path connection source ID 151. Through the above-described process, the flow path connection relationship information 53 can be generated from the symbol connection relationship information 52.

Generation of Flow Path Connection Information from Overlapping Order of Symbols

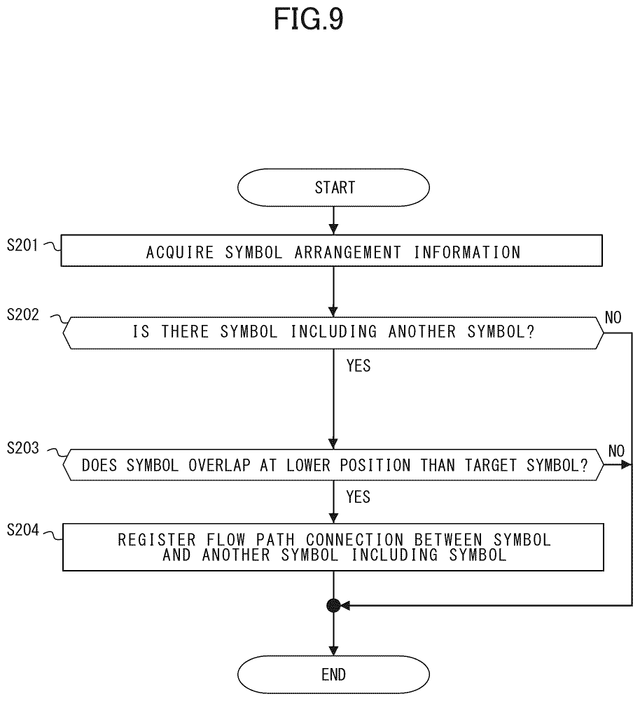

Next, a process in which the flow path form calculation unit 61 generates flow path connection relationship information 53 using symbol arrangement information 51 will be described with reference to a flowchart of FIG. 9. First, in step S201, the flow path form calculation unit 61 acquires symbol arrangement information 51.

Subsequently, in step S202, the flow path form calculation unit 61 calculates an inclusion relationship between symbols, and determines whether there are symbols in an inclusion relationship. Specifically, the flow path form calculation unit 61 calculates a center coordinate of a symbol figure 50 from the symbol arrangement information 51 acquired in step S201. Next, the flow path form calculation unit 61 determines whether there is a case where the center coordinate of the symbol figure 50 is included within a circumscribed rectangle of another symbol figure 50 among the symbols included in the symbol arrangement information 51. In some cases, such symbols are identified as being in an inclusion relationship with each other.

Subsequently, in step S203, the flow path form calculation unit 61 checks a Z order 515 between the symbols in the inclusion relationship specified in step S202. The flow path form calculation unit 61 specifies symbols having a relationship in which a Z order 515 of an including symbol is smaller than a Z order 515 of an included symbol.

Subsequently, in step S204, the flow path form calculation unit 61 registers a symbol ID 40 of the included symbol as a flow path connection source ID 151, and registers a symbol ID 40 of the including symbol as a flow path connection destination ID 152. In addition, the flow path form calculation unit 61 registers the symbol ID 40 of the including symbol as a flow path connection source ID 151, and registers the symbol ID 40 of the included symbol as a flow path connection destination ID 152.

Generation of Flow Path Form from Flow Path Connection Information

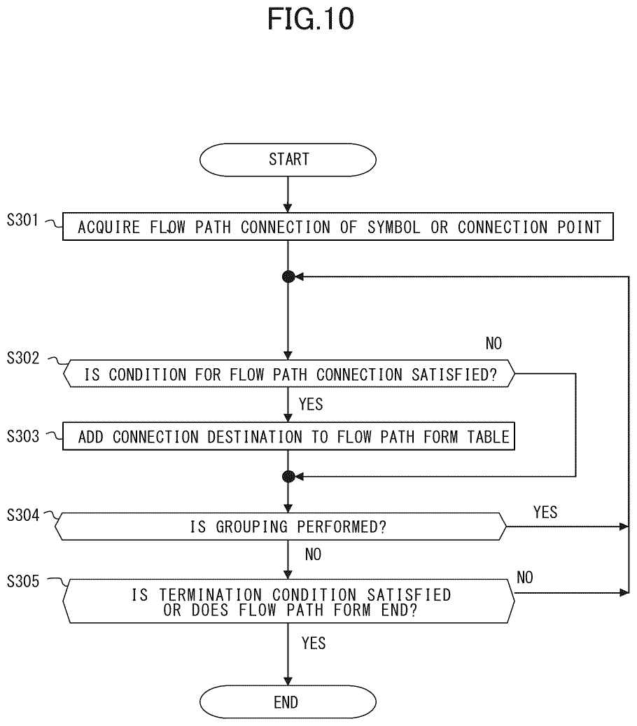

Next, a process in which the flow path form calculation unit 61 calculates a flow path form will be described with reference to a flowchart of FIG. 10. First, in step S301, the flow path form calculation unit 61 acquires a symbol ID 40 “B-2” selected by the user as information regarding a flow path connection source ID 151.

Subsequently, in step S302, the flow path form calculation unit 61 checks flow path connection availability 153 for the information specified in step S301. In this example, since the flow path connection availability 153 is not set for the information specified in step S301, the flow path form calculation unit 61 determines that the flow path connection is available.

Subsequently, in step S303, flow path connection destination IDs 152 for which the flow path form calculation unit 61 determines that the flow path connection is available, that is, “T-1” and “B-2_CP-1”, are registered in a flow path form table. Subsequently, in step S304, the flow path form calculation unit 61 confirms that a grouping flag 154 for “T-1” and “B-2_CP-1” which are flow path connection destination IDs 152, is OFF, and advances the process to step S305.

Subsequently, in step S305, the flow path form calculation unit 61 checks whether a termination condition for the flow path form is satisfied. When the termination condition is “until the next figure”, it can be determined from the symbol arrangement information 51 and symbol attribute information 91 that the shape type 543 of “T-1” is a “figure”. Therefore, the flow path form calculation unit 61 ends the process. Meanwhile, since “B-2_CP-1” is a connection point, the flow path form calculation unit 61 acquires “B-2_CP-1” and information using “B-2_CP-1” as a flow path connection source ID, and advances the process to step 302.

The flow path form calculation unit 61 completes the flow path form calculation process to specify the flow path form of the symbol ID 40 “B-2” as “T-1”, “B-2_CP-1”, “P-4_CP-1”, and “P-4”. That is, in the flow path structure, a range in which the fluid is allowed to flow from “B-2” selected by the user is specified as the flow path form.

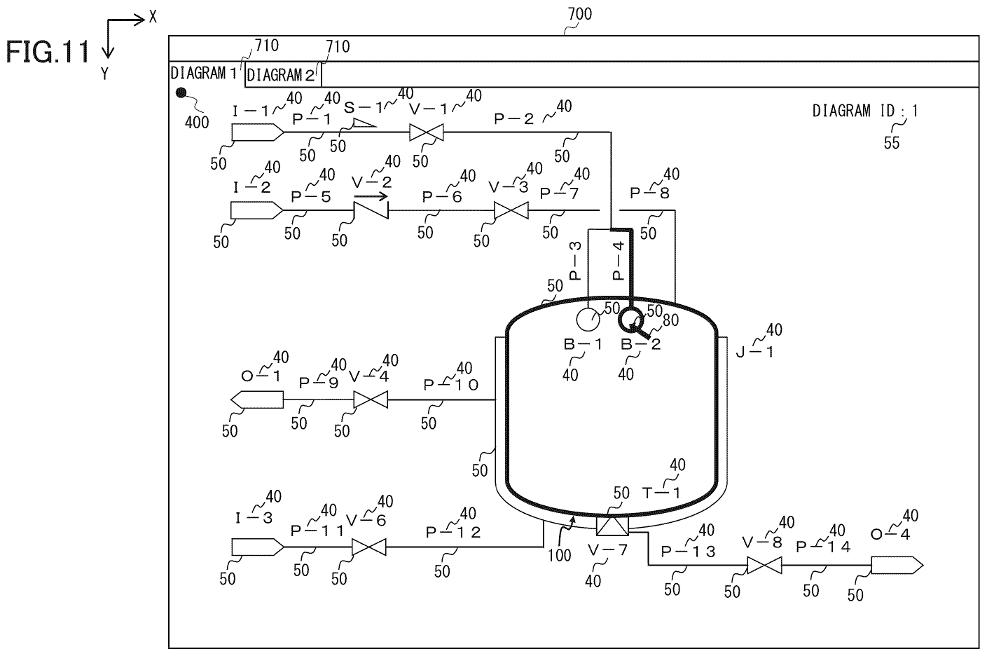

The flow path form calculation unit 61 can transmit the flow path form table to the display unit 7 and store the flow path form table in the storage unit. As illustrated in FIG. 11, the display unit 7 can display a flow path form on a diagram display screen 700. At that time, as illustrated in FIG. 11, it is preferable to display the flow path form, that is, the range in which the fluid is allowed to flow from “B-2” selected by the user, in a piping and instrumentation diagram in an easily distinguishable manner by, for example, thickening a line width, giving a color, giving a texture, or the like. By displaying the flow path form in the piping and instrumentation diagram, the user can easily recognize that the fluid flows from the spray ball “B-2” to the container “T-1”.

### Example 2

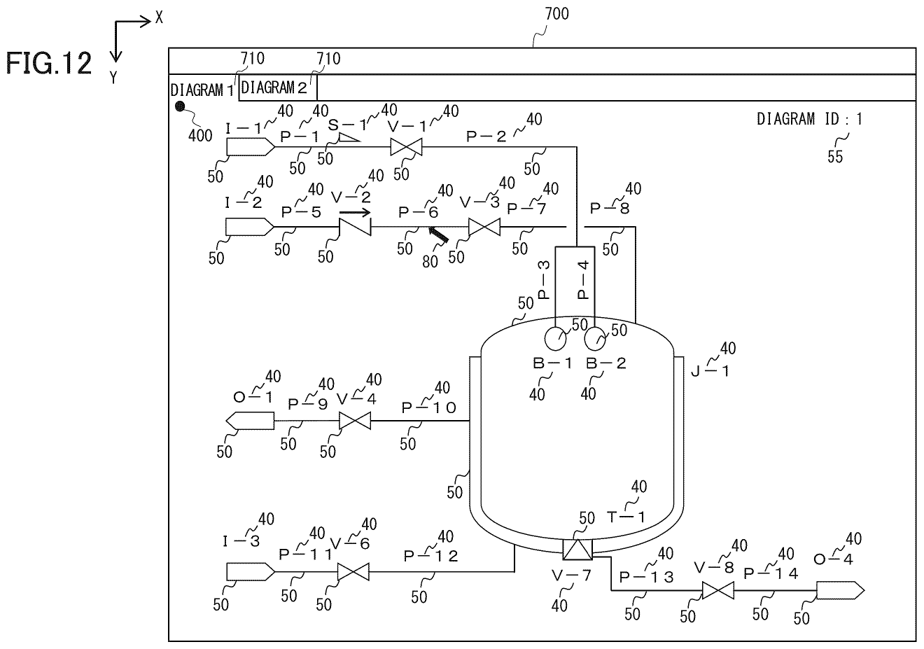

Next, another example of an information processing method according to the first embodiment will be described. Specifically, an example in which a flow path form is calculated using a flow path connection direction 541 that a connection point of a symbol has and symbol connection relationship information 52 will be described. FIG. 12 illustrates a diagram display screen 700 generated by the display unit 7 and displayed on the display device 1000 when the user selects a pipe of which the symbol ID 40 is “P-6” using the selection cursor 80.

The flow path form calculation unit 61 generates flow path connection relationship information 53 based on the selected symbol. Similarly to Example 1, the flow path form calculation unit 61 generates the flow path connection relationship information 53 from symbol connection relationship information 52.

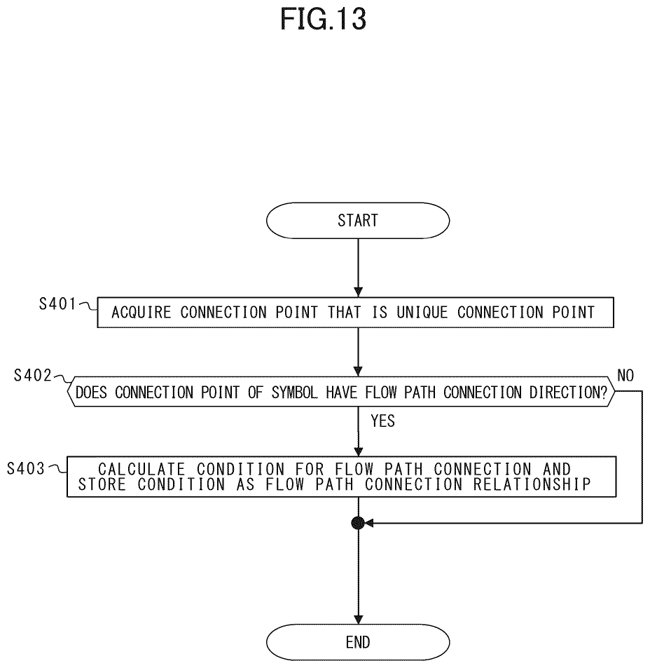

A process performed by the flow path form calculation unit 61, that is, a process of adding flow path connection availability 153 from the flow path connection direction 541, will be described with reference to a flowchart of FIG. 13. First, in step S401, the flow path form calculation unit 61 acquires flow path connection relationship information 53 and symbol connection relationship information 52, and acquires one of flow path connection source IDs 151 or flow path connection destination IDs 152 having a unique connection point ID 523. Here, the symbol ID 40 “V-2” has a connection point ID “V-2_CP-2”. Therefore, the flow path form calculation unit 61 can recognize that the symbol ID 40 “V-2” has a unique connection point ID “CP-D” from the symbol connection relationship information 52.

Subsequently, in step S402, a flow path connection direction 541 is acquired from the connection point acquired in step S401. Here, focusing on the connection point ID “V-2_CP-2” again, the flow path form calculation unit 61 acquires information regarding a flow path connection direction 541 associated with the unique connection point ID 523 “CP-D” from the symbol attribute information 91. Then, the flow path form calculation unit 61 stores information that the fluid does not flow in a direction to a check valve from the unique connection point ID 523 “CP-D”.

Subsequently, in step S403, the flow path form calculation unit 61 calculates flow path connection availability 153 of flow path connection relationship information 53 from the information regarding the flow path connection direction 541 acquired in step S402. Here, focusing again on the connection point ID “V-2_CP-2”, the connection point ID “V-2_CP-2” is a flow path connection source ID 151. Based on the information stored in step S402 by the flow path form calculation unit 61, it can be determined that the fluid does not flow to a flow path connection of which the flow path connection destination ID 152 is “V-2”. Therefore, the flow path form calculation unit 61 sets flow path connection availability 153 for the flow path connection destination ID 152 being “V-2” to “connection unavailable” (FIG. 6).

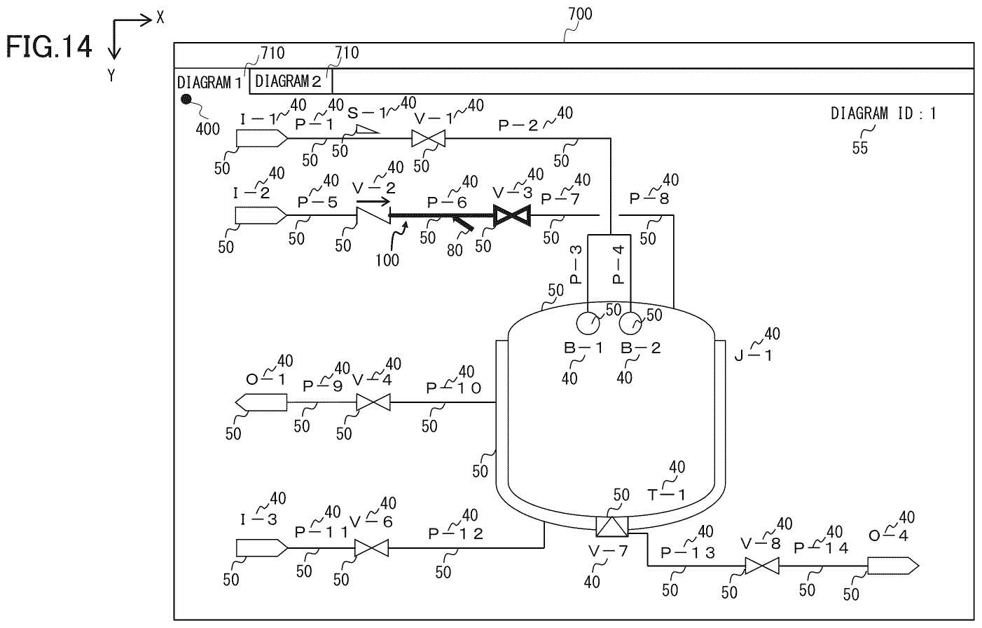

The flow path form calculation unit 61 acquires a flow path connection relationship up to the next symbol with the symbol ID 40 “P-6” selected by the user as a starting point (reference point), and adds the flow path connection relationship to a flow path form table. The flow path form calculation unit 61 can transmit the flow path form table to the display unit 7 and store the flow path form table in the storage unit. As illustrated in FIG. 14, the display unit 7 can display a flow path form 100 on a diagram display screen 700. At that time, as illustrated in FIG. 14, it is preferable to display the flow path form, that is, the range in which the fluid is allowed to flow from “P-6” selected by the user, in a piping and instrumentation diagram in an easily distinguishable manner by, for example, thickening a line width, giving a color, giving a texture, or the like. By displaying the flow path form in the piping and instrumentation diagram, the user can easily recognize that the fluid does not flow to the symbol ID “V-2” from the characteristics of the symbol.

### Example 3

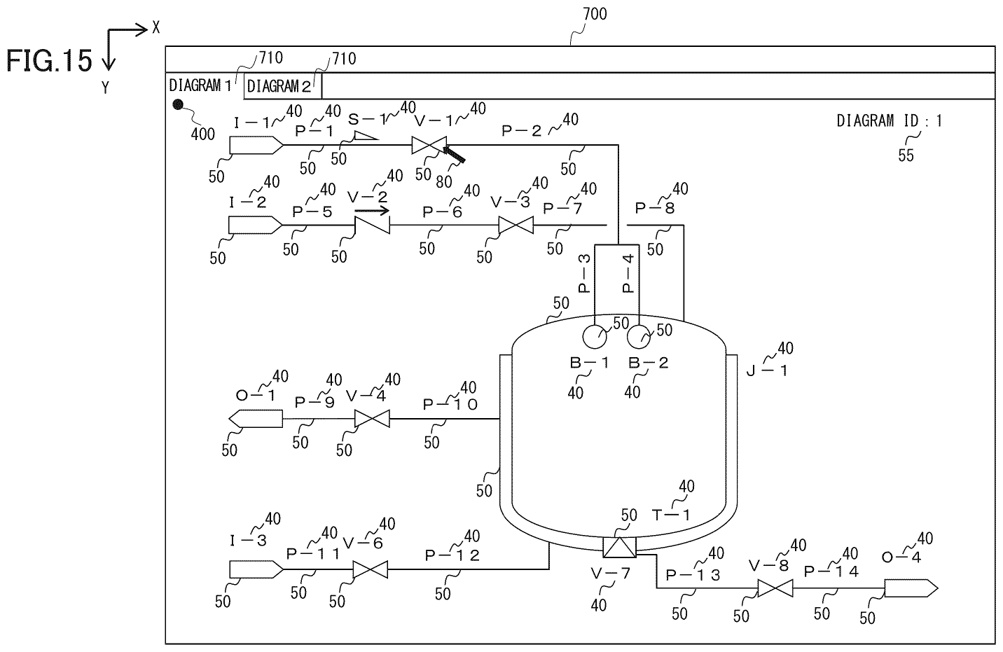

Next, another example of an information processing method according to the first embodiment will be described. Specifically, an example in which a flow path connection direction 541 is calculated from symbol arrangement information 51 will be described. FIG. 15 illustrates a diagram display screen 700 generated by the display unit 7 and displayed on the display device 1000 when the user selects a gate valve of which the symbol ID 40 is “V-1” using the selection cursor 80.

The flow path form calculation unit 61 generates flow path connection relationship information 53 based on the selected symbol. Similarly to Example 1, the flow path form calculation unit 61 generates the flow path connection relationship information 53 from symbol connection relationship information 52.

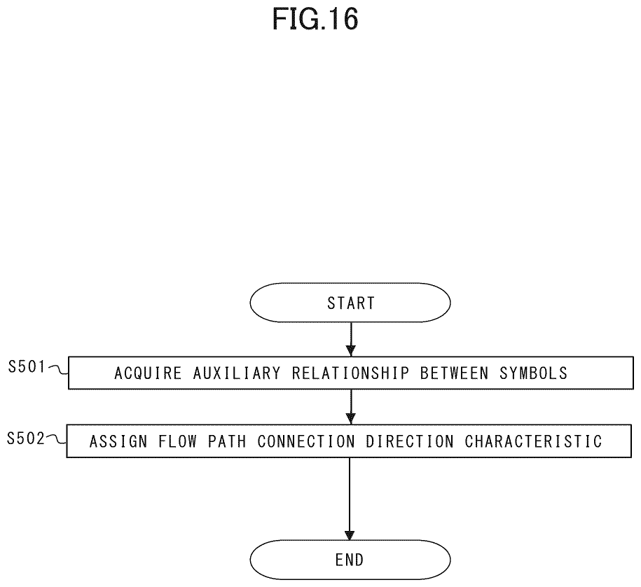

A process performed by the flow path form calculation unit 61, that is, a process of adding a flow path connection direction 541, will be described with reference to a flowchart of FIG. 16. First, in step S501, the flow path form calculation unit 61 acquires association between symbols from an auxiliary symbol ID 518 of symbol arrangement information 51. The auxiliary symbol ID 518 may be set by the user in advance, or the flow path form calculation unit 61 may register symbols of which symbol coordinates 511 are close to each other as an auxiliary symbol ID 518. Here, focusing on a symbol ID 40 “P-1”, a symbol ID 40 “S-1” is registered as an auxiliary symbol ID 518. Therefore, the flow path form calculation unit 61 can recognize that the connection point of the symbol ID 40 “P-1” is given a flow path connection direction 541 by the symbol ID 40 “S-1”.

Subsequently, in step S502, the flow path form calculation unit 61 assigns a flow path connection direction 541 of a connection point to the association between the symbols acquired in step S501 while referring to the symbol attribute information 91. Here, from information regarding the symbol IDs 40 “P-1” and “S-1”, the flow path form calculation unit 61 specifies that the symbol ID 40 “S-1” is a symbol of which the symbol name 517 is registered as “gradient” from the symbol figure 50.

Next, the flow path form calculation unit 61 acquires “ascending order of X coordinates” as a flow path connection direction giving characteristic 545 for the symbol of which the symbol name 517 is “gradient” (FIG. 4). Next, the flow path form calculation unit 61 specifies that the symbol of which the symbol ID 40 is “P-1” is a pipe of which the symbol name 517 is registered as “pipe” from the symbol figure 50. The flow path form calculation unit 61 applies “ascending order of X coordinates” of the flow path connection direction giving characteristic 545 as a flow path connection direction 541 to the specified symbol, that is, the symbol of which the symbol name 517 is “pipe”. As a result, the flow path connection direction 541 for “P-1” of which the symbol name 517 is “pipe” is “CP-H→pipe→CP-I”.

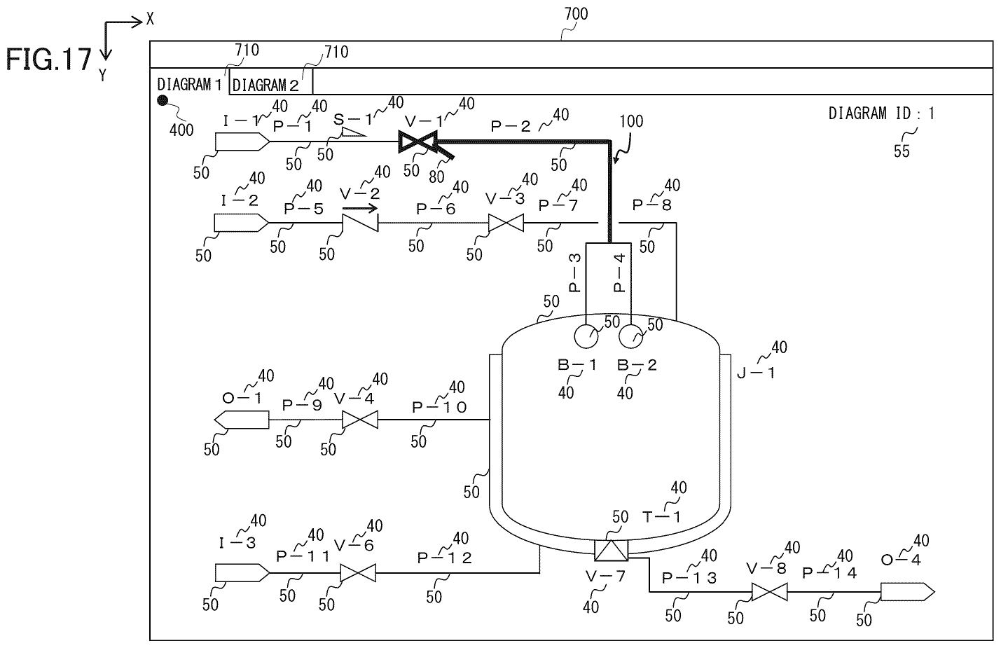

Thereafter, similarly to Example 2, the flow path form calculation unit 61 performs a process of adding flow path connection availability 153 from the flow path connection direction 541, and a process of calculating a flow path form 100. The flow path form calculation unit 61 can transmit information regarding the calculated flow path form to the display unit 7 and store the information in the storage unit. As illustrated in FIG. 17, the display unit 7 can display a flow path form 100 on a diagram display screen 700. At that time, as illustrated in FIG. 17, it is preferable to display the flow path form, that is, the range in which the fluid is allowed to flow from “V-1” selected by the user, in a piping and instrumentation diagram in an easily distinguishable manner by, for example, thickening a line width, giving a color, giving a texture, or the like. By displaying the flow path form in the piping and instrumentation diagram, the user can easily recognize the range in which the fluid flows even if the user does not notice that the pipe has a gradient.

In the present example, the flow path connection direction 541 of the connection point of the symbol ID 40 “P-1” is given by the symbol ID 40 “S-1” already stored in the symbol arrangement information 51. Conversely, by giving the flow path connection direction 541 of the connection point of the symbol ID 40 “P-1” in advance, the flow path form calculation unit 61 may add the symbol ID 40 “S-1” to the symbol arrangement information 51.

### Example 4

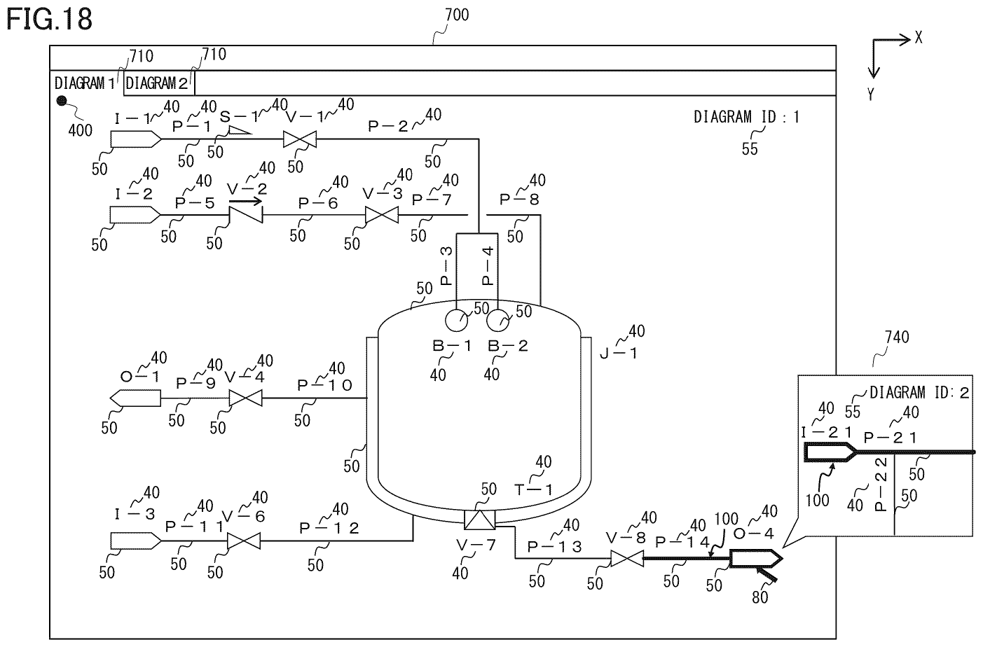

Next, another example of an information processing method according to the first embodiment will be described. Specifically, a method of displaying a flow path form across a plurality of diagrams without switching a diagram tab 710. FIG. 18 illustrates a diagram display screen 700 generated by the display unit 7 and displayed on the display device 1000 when the user selects an arrow wing (output) of which the symbol ID 40 is “O-4” using the selection cursor 80.

Similarly to Example 1, the flow path form calculation unit 61 generates flow path connection relationship information 53 from the selected symbol. A grouping flag 154 for symbol IDs 40 “O-4” and “I-21” of the flow path connection relationship information 53 is ON (FIG. 6). This indicates that an arrow wing (output) of which the symbol ID 40 is “O-4” depicted in diagram 1 and an arrow wing (input) of which the symbol ID 40 is “I-21” depicted in diagram 2 are connected to each other.

When displaying a flow path form 100, the display unit 7 checks whether a symbol included in the flow path form 100 is included in another diagram (that is, a diagram having a different diagram ID 55). When a symbol depicted in another diagram is included in the flow path form 100, the display unit 7 cuts out a portion corresponding to the flow path form 100 from the other diagram, generate an extra-screen flow path form display pop-up 740, and displays the generated pop-up so as to be contained in the display screen, as illustrated in FIG. 18. At that time, as illustrated in FIG. 18, it is preferable to display the flow path form, that is, the range in which the fluid is allowed to flow from “O-4” selected by the user, in a piping and instrumentation diagram in an easily distinguishable manner by, for example, thickening a line width, giving a color, giving a texture, or the like. Even when the range in which the fluid is allowed to flow from the point of interest spans different piping and instrumentation diagrams, the user can easily recognize a flow path form without performing a complicated operation for switching the display.

### Second Embodiment

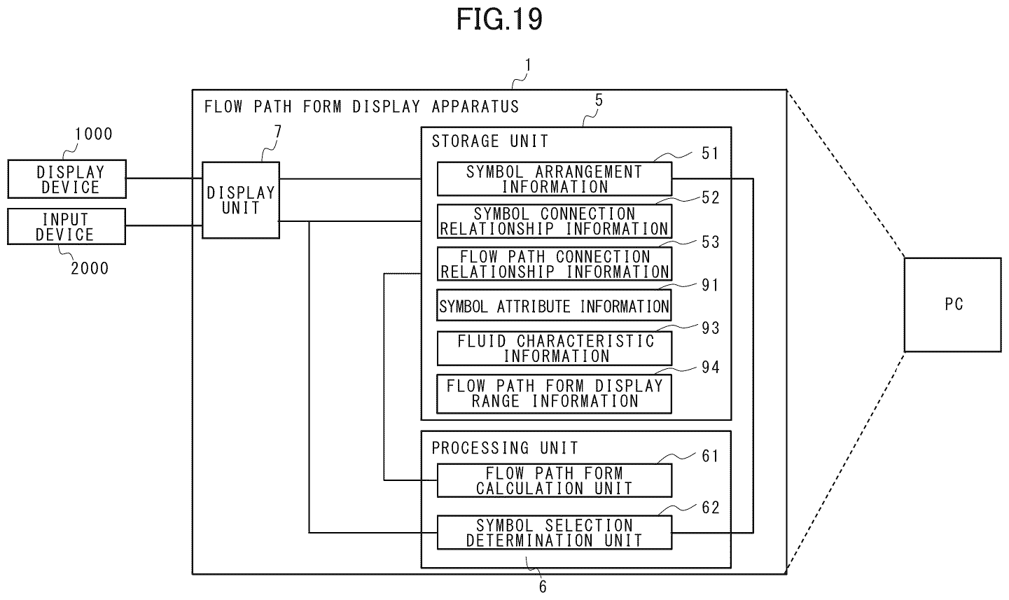

FIG. 19 is a schematic diagram for explaining an information processing apparatus capable of executing information processing for suitably displaying a state of a fluid in a flow path structure (a state in which the fluid flows in the flow path structure). In FIG. 19, elements necessary for explaining the features of the present embodiment are represented by blocks, but description of general elements not directly related to the problem solving principle of the present invention is omitted. Furthermore, the elements illustrated in FIG. 19 are conceptual, and do not necessarily need to be physically configured as illustrated. For example, the specific form in which the blocks are distributed or integrated is not limited to the illustrated example, and all or some of the blocks can be functionally or physically distributed or combined in arbitrary units according to the usage situation or the like. Meanwhile, description of matters common to the first embodiment will be simplified or omitted.

The present embodiment is different from the first embodiment illustrated in FIG. 1 in that the storage unit 5 includes fluid characteristic information 93 and flow path form display range information 94 as illustrated in FIG. 19.

### Fluid Characteristic Information

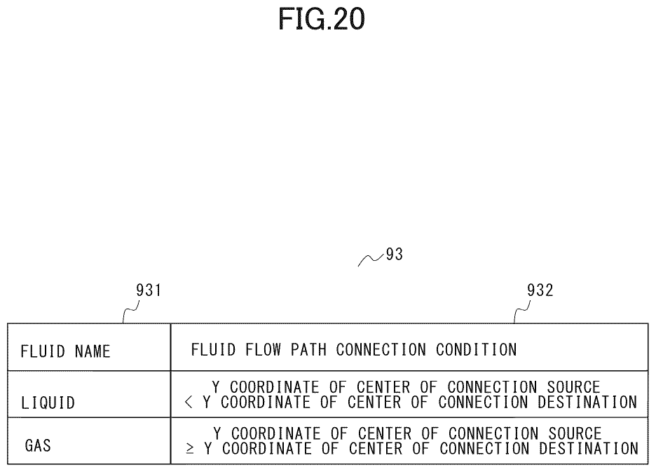

The fluid characteristic information 93 stored in the storage unit 5 will be described with reference to FIG. 20. The fluid characteristic information 93 includes a fluid name 931 and a fluid flow path connection condition 932. The fluid name 931 indicates a type of a fluid. The fluid flow path connection condition 932 is a conditional expression indicating a flowing direction of each of various fluids distinguished by the fluid name 931, and indicates that the fluid flows when the conditional expression is satisfied and the fluid does not flow when the conditional expression is not satisfied. The fluid flow path connection condition 932 is expressed by a conditional expression that can be calculated from the symbol arrangement information 51.

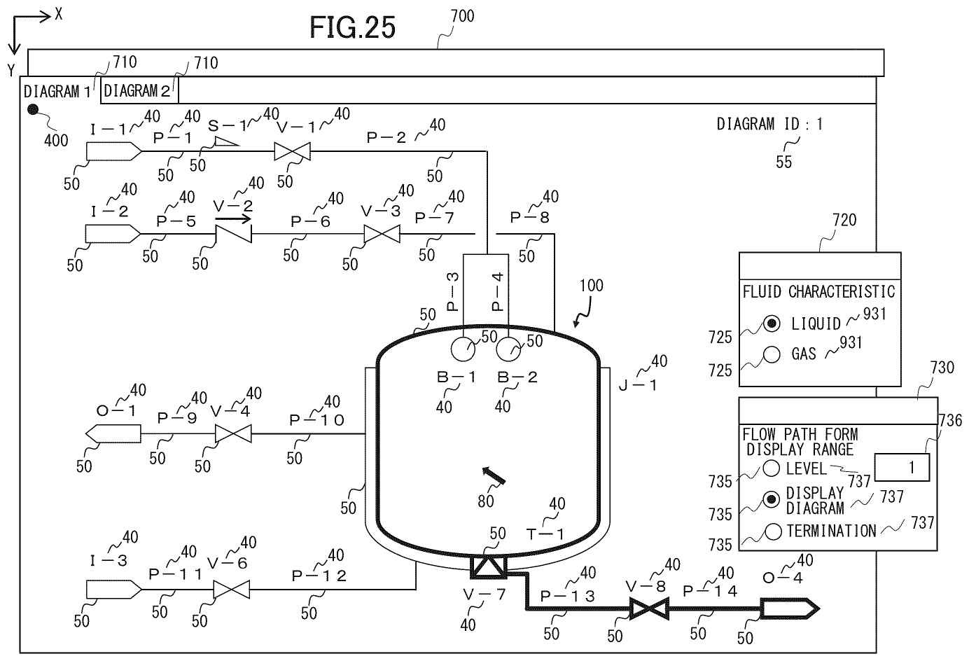

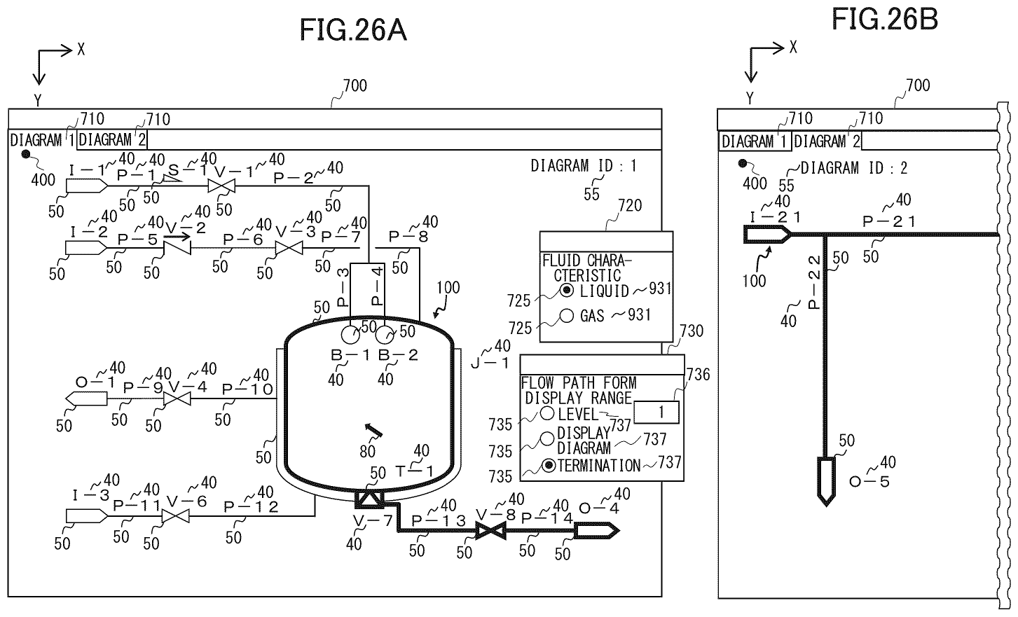

For example, when a fluid of which the fluid name 931 is registered as “liquid” is handled, if a pipe is installed with a gradient in the vertical direction in a flow path system where the fluid flows by the action of gravity, the fluid is regarded as flowing from the vertically upper side to the vertically lower side. Therefore, here, the Y-axis direction in FIGS. 25, 26A and 26B is regarded as the gravity direction, and the fluid flow path connection condition 932 is defined so that the fluid flows from a symbol having a small Y-coordinate value to a symbol having a large Y-coordinate value.

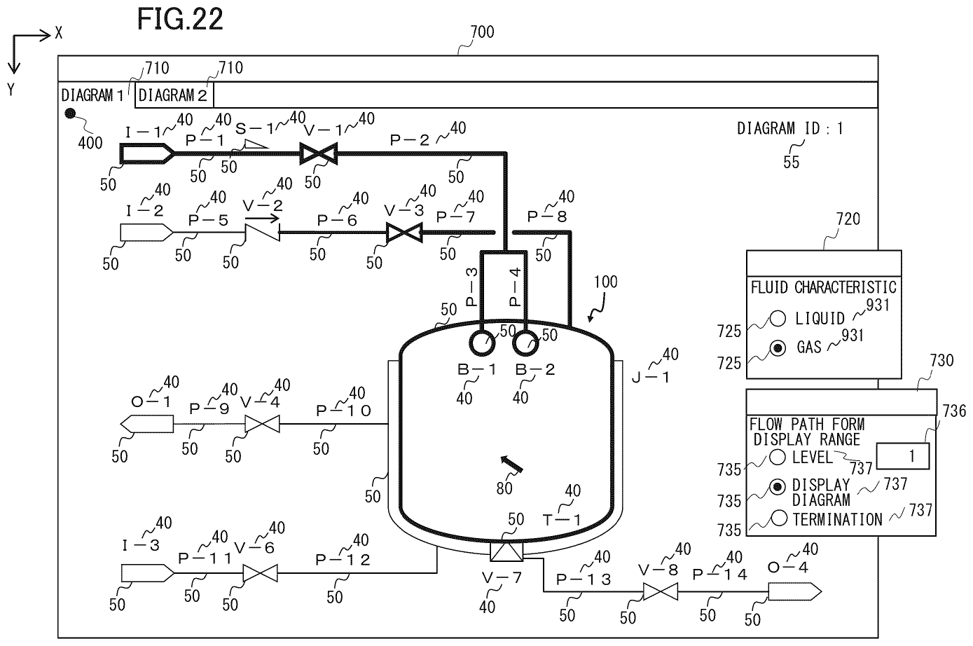

On the other hand, for example, when a fluid of which the fluid name 931 is registered as “gas”, if a pipe is installed with a gradient in the vertical direction in a flow path system where the fluid flows against the gravity direction, the fluid is regarded as flowing from the vertically lower side to the vertically upper side. Therefore, here, the Y-axis direction in FIGS. 22 to 24 is regarded as the gravity direction, and the fluid flow path connection condition 932 is defined so that the fluid flows from a symbol having a large Y-coordinate value to a symbol having a small Y-coordinate value.

### Flow Path Form Display Range Information

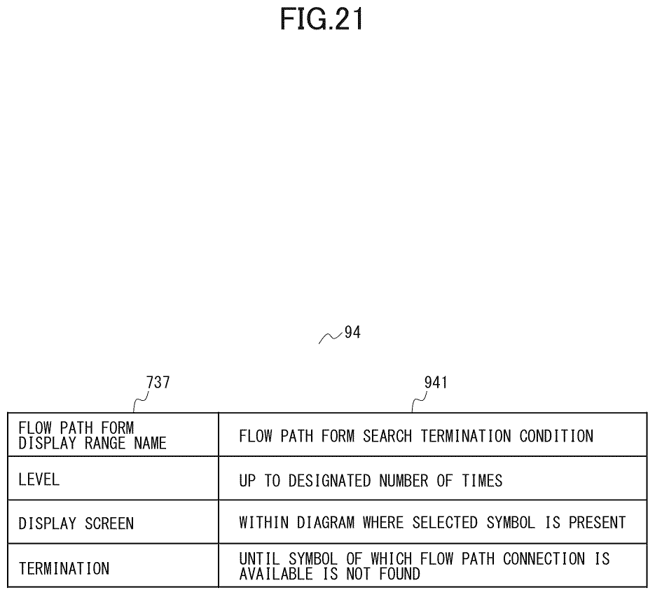

The flow path form display range information 94 stored in the storage unit 5 will be described with reference to FIG. 21. The flow path form display range information 94 includes a flow path form display range name 737 and a flow path form search termination condition 941. The flow path form display range name 737 is a unique name distinguishably expressing a flow path form search termination condition 941 to be described below. The flow path form search termination condition 941 is a termination condition for terminating the process of calculating the flow path form in step S305 of the flowchart illustrated in FIG. 10.

In the present embodiment, when the flow path form display range is “level”, a flow path form is calculated and displayed from a symbol serving as a starting point (reference point) up to the number of times designated in a flow path form display level input box 736 to be described below. That is, a range in which the fluid is allowed to flow from the symbol selected by the user is calculated and displayed to expand to a symbol of which the connection distance from the symbol selected by the user is the same as the designated number of times. When the flow path form display range is “display diagram”, a flow path form 100 is calculated and displayed within the range of the diagram in which a symbol serving as a starting point (reference point) is depicted. When the flow path form display range is “termination”, a flow path form 100 that can be calculated from a symbol serving as a starting point (reference point) is calculated and displayed to include a diagram other than the diagrams in which the symbol serving as the starting point (reference point) is depicted.

### Diagram Display Screen

Variations of display screens that can be generated and displayed by the display unit 7 will be described with reference to FIGS. 22 to 26B. On a display screen, in addition to a diagram display screen 700, an image of a fluid characteristic selection screen 720 and an image of a flow path display range selection screen 730 can be displayed.

The fluid characteristic selection screen 720 may include a fluid name 931 and a fluid characteristic radio button 725. The fluid characteristic radio button 725 is a radio button that enables a user to select which fluid flow path connection condition 932 (FIG. 20) is used to calculate a flow path form 100. The user can view the display of the fluid name 931, and easily select a type of a fluid to be handled with a radio button.

The flow path display range selection screen 730 may include a flow path form display range name 737, a fluid form display range radio button 735, and a flow path form display level input box 736. The fluid form display range radio button 735 is a radio button that enables a user to select which flow path form search termination condition 941 (FIG. 21) is used to calculate a flow path form 100 when displaying the flow path form 100. The user can easily select a flow path form display range using the fluid form display range radio button 735 while viewing the display of the flow path form display range name 737 described with reference to FIG. 21.

The flow path form display level input box 736 is an input field for the user to specify a range of a flow path form 100 to be generated with the selected symbol as the starting point (reference point) when “level” is selected as a flow path form display range. The user can specify a range of a flow path form 100 to be generated by inputting the maximum number of symbols that can be connected to each other in series from the starting point (reference point). In other words, the user can designate a termination condition (the number of calculations until the termination) of the calculation process for obtaining a flow path form 100 illustrated in FIG. 10. Meanwhile, the value input in the flow path form display level input box 736 may function to designate a range for displaying a calculation result, rather than designating a range for calculation processing. For example, even if the result of calculating the range in which the fluid is allowed to flow is up to the fourth symbol connected in series from the starting point (reference point), when the value input in the flow path form display level input box 736 is “2”, up to the second symbol may be identifiably displayed.

### Example 5

FIG. 22 illustrates a diagram display screen 700 when the user selects a symbol (container) of which the symbol ID 40 is “T-1” using the selection cursor 80. The flow path form calculation unit 61 generates flow path connection relationship information 53 from the selected symbol. Similarly to the other examples, the flow path form calculation unit 61 generates the flow path connection relationship information 53.

In this example, on the fluid characteristic selection screen 720, “gas” is selected using a fluid characteristic radio button 725, and the flow path form calculation unit 61 acquires a fluid flow path connection condition 932 (FIG. 20). The flow path form calculation unit 61 acquires flow path connection availability 153 (FIG. 6) using the fluid flow path connection condition 932 for gas.

Next, the flow path form calculation unit 61 performs a process of calculating a flow path form 100. In this example, since “display screen” is selected on the flow path display range selection screen 730, a flow path form 100 is calculated and displayed within the range of diagram 1 selected with a diagram tab 710. At that time, as illustrated in FIG. 22, it is preferable to display the flow path form, that is, the range in which the gas is allowed to flow from the container “T-1” selected by the user, in a piping and instrumentation diagram in an easily distinguishable manner by, for example, thickening a line width, giving a color, giving a texture, or the like. Although a spray ball disposed in the container is not directly connected to the container itself by a pipe, it can be easily understood that gas is allowed to flow between the spray ball and the container. By displaying the flow path form in the piping and instrumentation diagram, the user can easily recognize the range in which the gas flows from the container T-1.

### Example 6

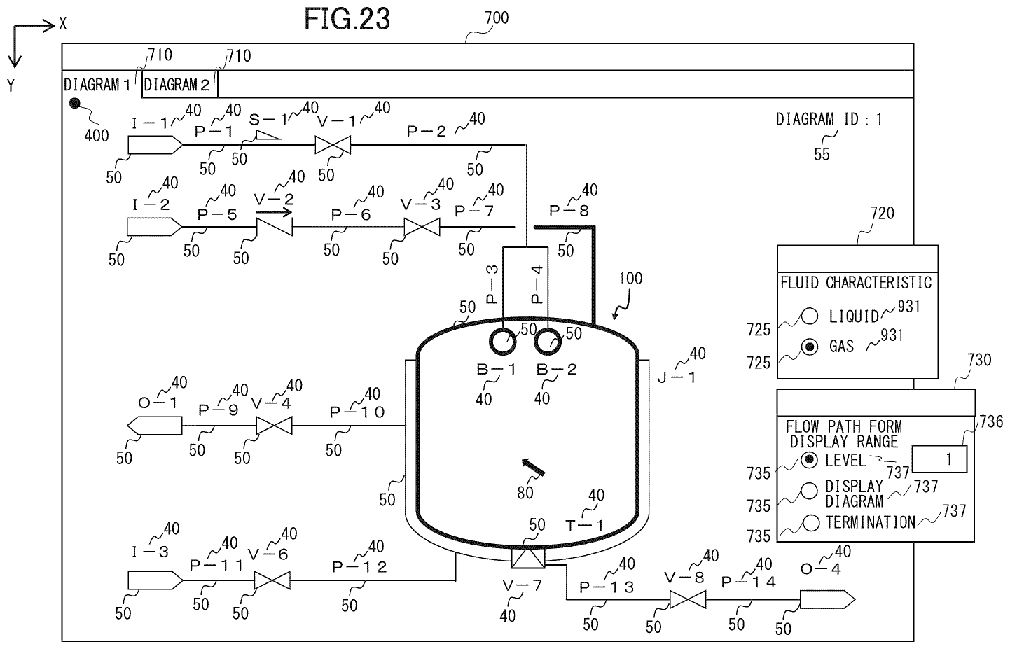

FIG. 23 illustrates another example of a diagram display screen 700 when the user selects a symbol (container) of which the symbol ID 40 is “T-1” using the selection cursor 80. The flow path form calculation unit 61 generates flow path connection relationship information 53 from the selected symbol. Similarly to the other examples, the flow path form calculation unit 61 generates the flow path connection relationship information 53.

In this example, on the fluid characteristic selection screen 720, “gas” is selected using a fluid characteristic radio button 725, and the flow path form calculation unit 61 acquires a fluid flow path connection condition 932 (FIG. 20). The flow path form calculation unit 61 acquires flow path connection availability 153 (FIG. 6) using the fluid flow path connection condition 932 for gas.

Next, the flow path form calculation unit 61 performs a process of calculating a flow path form 100. In this example, “level” is selected on the flow path display range selection screen 730, and “1” is input in the flow path form display level input box 736. Therefore, the flow path form calculation unit 61 calculates and displays a flow path form 100 within the range of one symbol connected in series with the symbol serving as a starting point (reference point) of which the symbol ID 40 is “T-1”. At that time, as illustrated in FIG. 23, it is preferable to display the flow path form, that is, the range in which the gas is allowed to flow from the container “T-1” selected by the user, in a piping and instrumentation diagram in an easily distinguishable manner by, for example, thickening a line width, giving a color, giving a texture, or the like. By displaying the flow path form in the piping and instrumentation diagram, the user can easily recognize the range in which the gas flows for the symbol adjacent to the container T-1.

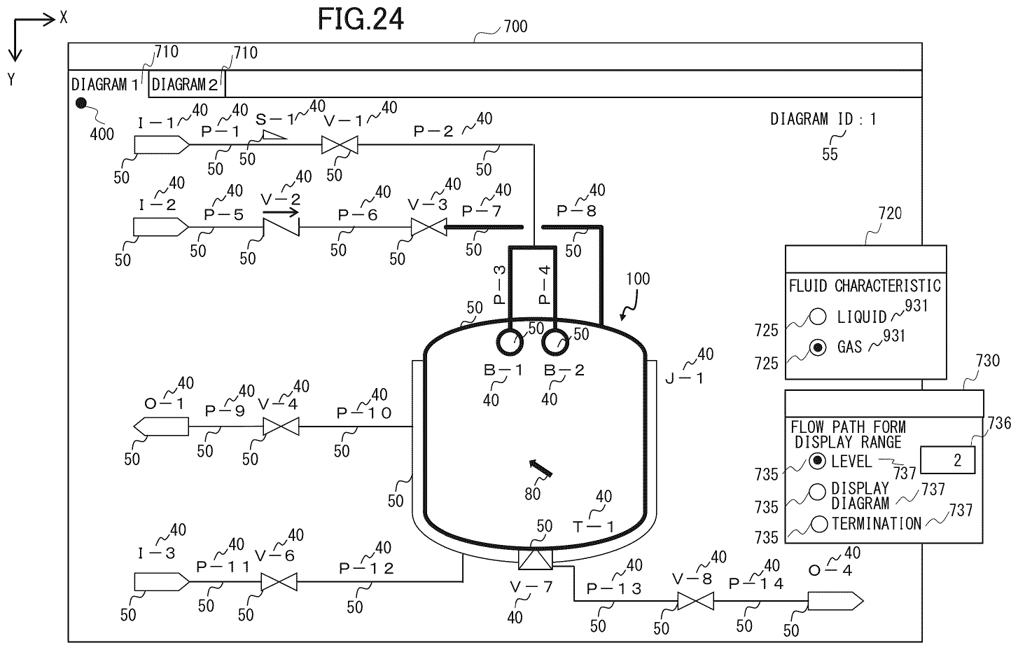

In addition, FIG. 24 illustrates a case where “2” is input in the flow path form display level input box 736. The flow path form calculation unit 61 calculates and displays a flow path form 100 within the range of two symbols connected in series with the symbol serving as a starting point (reference point) of which the symbol ID 40 is “T-1”. At that time, as illustrated in FIG. 24, it is preferable to display the flow path form, that is, the range in which the gas is allowed to flow from the container “T-1” selected by the user, in a piping and instrumentation diagram in an easily distinguishable manner by, for example, thickening a line width, giving a color, giving a texture, or the like. By displaying the flow path form in the piping and instrumentation diagram, the user can easily recognize the range in which the gas flows within the range of two symbols connected in series with the container T-1.

### Example 7

FIG. 25 illustrates a diagram display screen 700 when the user selects a symbol (container) of which the symbol ID 40 is “T-1” using the selection cursor 80. The flow path form calculation unit 61 generates flow path connection relationship information 53 from the selected symbol. Similarly to the other examples, the flow path form calculation unit 61 generates the flow path connection relationship information 53.

In this example, on the fluid characteristic selection screen 720, “liquid” is selected using a fluid characteristic radio button 725, and the flow path form calculation unit 61 acquires a fluid flow path connection condition 932 (FIG. 20). The flow path form calculation unit 61 acquires flow path connection availability 153 (FIG. 6) using the fluid flow path connection condition 932 for liquid.

Next, the flow path form calculation unit 61 performs a process of calculating a flow path form 100. In this example, since “display screen” is selected on the flow path display range selection screen 730, a flow path form 100 is calculated and displayed within the range of diagram 1 selected with a diagram tab 710. In this example, since the fluid is liquid, the flow path form 100 is calculated as flowing along the direction of gravity. At that time, as illustrated in FIG. 25, it is preferable to display the flow path form, that is, the range in which the liquid is allowed to flow from the container “T-1” selected by the user, in a piping and instrumentation diagram in an easily distinguishable manner by, for example, thickening a line width, giving a color, giving a texture, or the like. By displaying the flow path form in the piping and instrumentation diagram, the user can easily recognize the range in which the liquid flows from the container T-1.

### Example 8

FIGS. 26A and 26B illustrate another example of a diagram display screen 700 when the user selects a symbol (container) of which the symbol ID 40 is “T-1” using the selection cursor 80. The flow path form calculation unit 61 generates flow path connection relationship information 53 from the selected symbol. Similarly to the other examples, the flow path form calculation unit 61 generates the flow path connection relationship information 53.

In this example, on the fluid characteristic selection screen 720, “liquid” is selected using a fluid characteristic radio button 725, and the flow path form calculation unit 61 acquires a fluid flow path connection condition 932 (FIG. 20). The flow path form calculation unit 61 acquires flow path connection availability 153 (FIG. 6) using the fluid flow path connection condition 932 for liquid.

Next, the flow path form calculation unit 61 performs a process of calculating a flow path form 100. In this example, since “termination” is selected on the flow path display range selection screen 730, a flow path form 100 that can be calculated from a symbol serving as a starting point (reference point) is calculated and displayed to include a diagram other than the diagrams in which the symbol serving as the starting point (reference point) is depicted. Similarly to Example 1, the flow path form calculation unit 61 generates flow path connection relationship information 53 from the selected symbol. In this example, a grouping flag 154 for symbol IDs 40 “O-4” and “I-21” of the flow path connection relationship information 53 is ON (FIG. 6). This indicates that an arrow wing (output) of which the symbol ID 40 is “O-4” depicted in diagram 1 and an arrow wing (input) of which the symbol ID 40 is “I-21” depicted in diagram 2 are connected to each other.

In this example, it is assumed that the flow path form 100 in which the liquid flows extend to the flow path structure depicted in diagram 2 of which the diagram ID is “2” via an arrow wing (output) of which the symbol ID 40 is “O-4” from the container serving as a starting point (reference point) of which the symbol ID 40 is “T-1”.

First, as shown in FIG. 26A, a flow path form 100 can be displayed within the range of diagram 1 selected by the user with a diagram tab 710. In addition, as illustrated in FIG. 26B, when the user selects diagram 2 with a diagram tab 710, a flow path form 100 can be calculated and displayed within the range of diagram 2. In addition, as illustrated in FIG. 18, the display unit 7 may cut out a portion corresponding to the flow path form 100 from diagram 2, generate an extra-screen flow path form display pop-up 740, and display the generated pop-up 740 together with diagram 1 so as to be contained in the display screen. Alternatively, diagrams 1 and 2 may be reduced at an appropriate magnification, and FIG. 26A and FIG. 26B may be displayed side by side on the same display screen.

In other words, the flow path structure is expressed with a plurality of diagrams in a divided manner, and the range in which the fluid is allowed to flow from the reference point can be displayed on the display unit within the range of the diagram in which the reference point is depicted among the plurality of diagrams. Further, when the range in which the fluid is allowed to flow from the reference point extends not only to the diagram in which the reference point is depicted but also to another diagram, the diagram in which the reference point is depicted and the another diagram can be edited and displayed on the display unit.

At this time, it is preferable to display the flow path form, that is, the range in which the liquid is allowed to flow from the container “T-1” selected by the user, in a piping and instrumentation diagram in an easily distinguishable manner by, for example, thickening a line width, giving a color, giving a texture, or the like. Even when the range in which the fluid is allowed to flow from the point of interest spans different piping and instrumentation diagrams, the user can easily recognize a flow path form. In the process of calculating the flow path form 100 (FIG. 10), the termination condition in step S305 is calculated using a flow path form search termination condition 941 selected using a fluid form display range radio button 735.

### Modification

Note that the present invention is not limited to the above-described embodiments and examples, and many modifications can be made within the technical spirit of the present invention. For example, all or some of the different embodiments and examples described above may be combined for implementation.

For example, although it has been described as an example that liquid, which is a fluid, flows in the vertical direction by the action of gravity, the target to which the information processing method and the information processing apparatus according to the present invention are to be applied is not limited to such a flow path system. For example, in a case where the flow path system includes an element capable of applying a force other than gravity to the fluid, such as a pressurizing device, a depressurizing device, or a pump, information processing is performed with a symbol of the element associated with a flow path connection direction giving characteristic or the like according to a characteristic of the device.

In addition, for example, depending on the type of fluid (for example, whether the fluid is liquid, gas, water, an organic solvent, or the like), a state in which the fluid flows in a flow path structure (flow path form) in a piping and instrumentation diagram may be displayed in a different color, or may be displayed with a different line width or a different line type (solid line, dotted line, etc.). Alternatively, identification information (character, mark, or the like) for the user to recognize a type of a flowing fluid may be added to each flow path in a piping and instrumentation diagram. That is, it is possible to acquire information regarding a type of a fluid as information regarding a characteristic of the fluid, edit a diagram so that the type of the fluid flowing through the flow path structure can be identified, and display the edited diagram on the display unit.

Furthermore, in the information processing method and the information processing apparatus according to the present invention, since the user inputs or edits the information included in the tables illustrated in FIGS. 3-6, 20, and 21, the tables illustrated in FIGS. 3-6, 20, and 21 can be displayed on the display unit, and an input can be received from the user.

A process which can be designed or of which an operation can be confirmed by applying the information processing method and the information processing apparatus according to the present invention is typically a process related to manufacturing of an article performed using an apparatus having a flow path structure, such as processing or cleaning of a component, or synthesis of a material. However, in flow path systems including water treatment systems and chemical plants, the information processing method and the information processing apparatus according to the present invention can also be applied in order to design and confirm processes other than the above-described processes performed using the apparatus having a flow path structure.

The present invention can also be realized by processing in which a program for implementing one or more functions of the embodiments is supplied to a system or an apparatus via a network or a storage medium, and one or more processors in a computer of the system or the apparatus read and execute the program. The present invention can also be realized by a circuit (e.g., ASIC) that implements one or more functions.

According to the present invention, it is possible to display a state of a fluid in a flow path structure (a state in which the fluid flows in the flow path structure) in a piping and instrumentation diagram expressed by using symbols in an easily understandable form.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-105593, filed Jun. 28, 2023, which is hereby incorporated by reference herein in its entirety.

What is claimed is:

1. An information processing method comprising:
by a processing unit,
displaying, on a display unit, a diagram in which a flow path structure is expressed using a plurality of symbols representing components of a flow path;
acquiring a designation of a symbol to be treated as a reference point among the plurality of symbols;
calculating a range in which a fluid is allowed to flow from the reference point in the flow path structure using information regarding arrangement of the plurality of symbols and attribute information associated with each of the plurality of symbols; and
editing the diagram to identify the range and displaying the edited diagram on the display unit.

2. The information processing method according to claim 1, wherein
the attribute information includes information regarding a direction in which the fluid is allowed to flow in a component represented by a corresponding one of the symbols.

3. The information processing method according to claim 1, wherein
the information regarding the arrangement of the plurality of symbols includes information regarding whether a component represented by a certain symbol and a component represented by a symbol adjacent thereto are directly connected to each other by a pipe.

4. The information processing method according to claim 1, wherein
the processing unit is configured to: display, on the display unit, an image to be used for acquiring information regarding a characteristic of the fluid; and
calculate the range using the acquired information regarding the characteristic of the fluid and the attribute information.

5. The information processing method according to claim 4, wherein
the information regarding the characteristic of the fluid includes information on whether the fluid is gas or liquid.

6. The information processing method according to claim 4, wherein
the information regarding the characteristic of the fluid includes information regarding a type of the fluid, and
the processing unit is configured to edit the diagram to identify the type of the fluid flowing in the flow path structure, and display the edited diagram on the display unit.

7. The information processing method according to claim 1, wherein
the processing unit is configured to acquire a designation of a maximum number of symbols connectable to each other in series from the reference point for calculating the range, and calculate the range based on the designation.

8. The information processing method according to claim 1, wherein
the processing unit is configured to acquire a designation of a maximum number of symbols connectable to each other in series from the reference point for displaying the range, and display the range on the display unit based on the designation.

9. The information processing method according to claim 1, wherein
the flow path structure is expressed with a plurality of diagrams in a divided manner, and
the range in which the fluid is allowed to flow from the reference point is displayed on the display unit within a range of a diagram in which the reference point is depicted among the plurality of diagrams.

10. The information processing method according to claim 1, wherein
the flow path structure is expressed with a plurality of diagrams in a divided manner, and
in a case where the range in which the fluid is allowed to flow from the reference point extends not only to a diagram in which the reference point is depicted but also to another diagram, the diagram in which the reference point is depicted and the another diagram are edited, and the edited diagrams are displayed on the display unit.

11. A computer-readable recording medium recording a program for causing the processing unit to execute the information processing method according to claim 1.

12. An information processing apparatus comprising a processing unit,
wherein the processing unit is configured to:
display, on a display unit, a diagram in which a flow path structure is expressed using a plurality of symbols representing components of a flow path;
acquire a designation of a symbol to be treated as a reference point among the plurality of symbols;
calculate a range in which a fluid is allowed to flow from the reference point in the flow path structure using information regarding arrangement of the plurality of symbols and attribute information associated with each of the plurality of symbols; and
edit the diagram to identify the range and display the edited diagram on the display unit.

13. The information processing apparatus according to claim 12, wherein
the attribute information includes information regarding a direction in which the fluid is allowed to flow in a component represented by a corresponding one of the symbols.

14. The information processing apparatus according to claim 12, wherein
the information regarding the arrangement of the plurality of symbols includes information regarding whether a component represented by a certain symbol and a component represented by a symbol adjacent thereto are directly connected to each other by a pipe.

15. The information processing apparatus according to claim 12, wherein
the processing unit is configured to: display, on the display unit, an image to be used for acquiring information regarding a characteristic of the fluid; and
calculate the range using the acquired information regarding the characteristic of the fluid and the attribute information.

16. The information processing apparatus according to claim 15, wherein
the information regarding the characteristic of the fluid includes information on whether the fluid is gas or liquid.

17. The information processing apparatus according to claim 15, wherein
the information regarding the characteristic of the fluid includes information regarding a type of the fluid, and
the processing unit is configured to edit the diagram to identify the type of the fluid flowing in the flow path structure, and display the edited diagram on the display unit.

18. The information processing apparatus according to claim 12, wherein
the processing unit is configured to acquire a designation of a maximum number of symbols connectable to each other in series from the reference point for calculating the range, and calculate the range based on the designation.

19. The information processing apparatus according to claim 12, wherein
the processing unit is configured to acquire a designation of a maximum number of symbols connectable to each other in series from the reference point for displaying the range, and display the range on the display unit based on the designation.

20. The information processing apparatus according to claim 12, wherein
the flow path structure is expressed with a plurality of diagrams in a divided manner, and
the range in which the fluid is allowed to flow from the reference point is displayed on the display unit within a range of a diagram in which the reference point is depicted among the plurality of diagrams.

21. The information processing apparatus according to claim 12, wherein
the flow path structure is expressed with a plurality of diagrams in a divided manner, and
in a case where the range in which the fluid is allowed to flow from the reference point extends not only to a diagram in which the reference point is depicted but also to another diagram, the diagram in which the reference point is depicted and the another diagram are edited, and the edited diagrams are displayed on the display unit.
